(19) United States
(12) Patent Application Publication
(10) Pub. No.: US 2016/0046487 A1
(43) Pub. Date: Feb. 18, 2016

(54) SYSTEM, APPARATUS, AND METHOD TO MECHANICALLY AND CHEMICALLY CONVERT THE ELEMENT SILICON IN A WATER SPLIT REACTION

(71) Applicant: Douglas Stark, Mt. Airy, MD (US)

(72) Inventor: Douglas Stark, Mt. Airy, MD (US)

(21) Appl. No.: 14/872,663

(22) Filed: Oct. 1, 2015

Related U.S. Application Data
(62) Division of application No. 14/457,211, filed on Aug. 12, 2014.

(51) Int. Cl. C01B 3/06; B01J 19/18

(52) U.S. Cl. CPC C01B 3/06; B01J 19/18

(57) ABSTRACT

A system and method for using silicon as an energy carrier as an alternative to hydrocarbon fuel. The method may include using energy to purify and refine silicon, and converting it into useful feedstock to be fed into a reactor system. The reactor system provides an environment in which silicon may be abraded or chemically treated and may then be reacted with water to form hydrogen gas. This hydrogen gas may then be directly used or stored, and the silicon used in the reaction may be recycled as desired.

### BACKGROUND

The modern energy economy is in large part based around hydrocarbon fuels, and such reliance is becoming increasingly problematic. While global reserves of coal, oil, and natural gas are finite and diminishing, global energy requirements are dramatically increasing and are expected to continue to do so for the foreseeable future. It is questionable whether hydrocarbon fuels will be able to meet this rising demand at all, and highly likely that the costs of using them will only continue to grow. Hydrocarbon fuels already suffer from undesirable inefficiencies from difficulty of extraction, and this is likely to grow worse in the future as the most easily-accessible reservoirs of hydrocarbon fuel are depleted. Furthermore, the devices used to convert the energy stored within hydrocarbon fuel sources into usable work themselves suffer from marked inefficiencies. Lastly, the oxidation of hydrocarbon fuels is a major source of greenhouse gases and a major contributor to global warming.

Hydrogen gas has often been seen as a potential alternative energy carrier that could be used to supplement or replace hydrocarbon fuel in many of the areas where it is used. This is somewhat justified, as hydrogen has a number of characteristics that make it suited for this purpose; it is relatively abundant, offers a reasonably high energy density, may be safely transported and stored given that the appropriate precautions are taken, and can potentially be produced by renewable energy sources. However, hydrogen gas is still less safe than hydrocarbon fuels, and lacks comparable energy density. Furthermore, many methods of industrially producing hydrogen gas require that it be produced from hydrocarbon fuels, which is less than ideal if it is to function as a true alternative. There is a need for a method by which hydrogen-based fuel may be made safer, more energy-efficient, more energy-dense, and more easily transferred and stored.

### SUMMARY

A system and method for employing silicon as a supplement or replacement for current hydrogen storage techniques may each be disclosed. The method may include generating or using energy from an energy source, using this energy to purify and refine silicon to an acceptable level of purity, transporting the purified and refined silicon to a place of use, reacting the purified and refined silicon with water in a particular environment or in a particular system in order to produce hydrogen gas and other products, and storing or directly using the generated hydrogen while optionally recycling the other products.

Furthermore, a particular system for reacting the purified and refined silicon with water in order to generate hydrogen gas may also be disclosed. Such a system may be governed by a central control device, and may employ a silicon supply, a water supply, and a supply of a chemical base. Water and the base may be mixed to produce a basic solution, which may then be reacted with silicon to yield silicates and other products, hydrogen, and, potentially, unused reactants. Hydrogen may be stored or may be put to immediate use.

### BRIEF DESCRIPTION OF THE FIGURES

Advantages of embodiments of the present invention will be apparent from the following detailed description of the exemplary embodiments. The following detailed description should be considered in conjunction with the accompanying figures.

FIG. 1 displays an exemplary process wherein elemental silicon may function as an energy storage medium.

FIG. 2 displays an exemplary system that may be used to react elemental silicon feedstock with other reactants to produce hydrogen gas.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

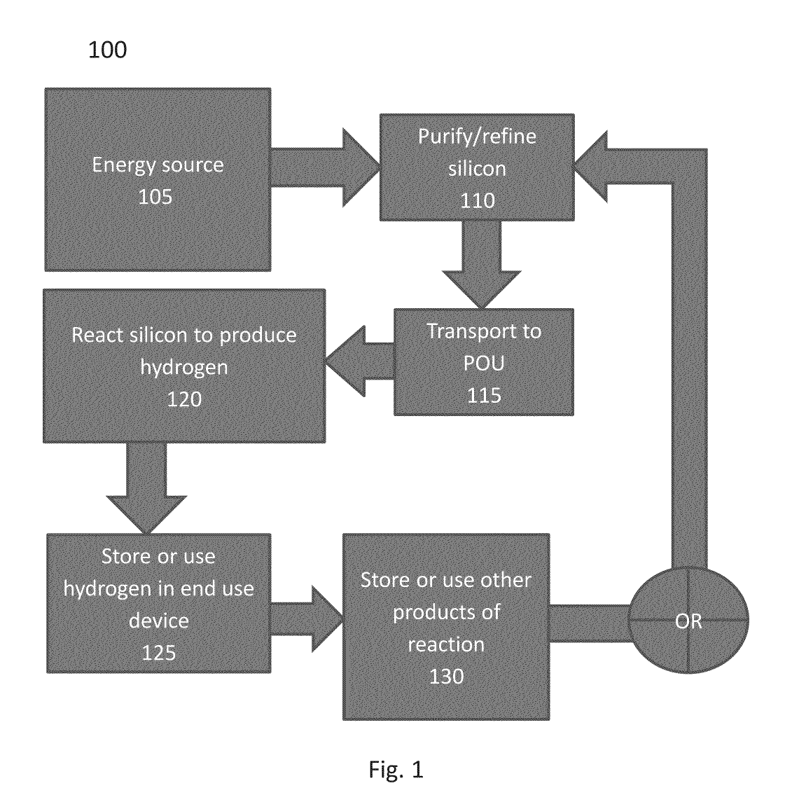

An exemplary embodiment of a process for employing silicon as an energy storage medium 100 is described in FIG. 1. This process may include generating or using energy from an energy source 105, using this energy to purify and refine silicon to an acceptable level of purity 110, transporting the purified and refined silicon to a place of use 115, reacting the purified and refined silicon with water in a particular environment to produce hydrogen gas and other products 120, and storing or directly using the generated hydrogen 125. Optionally, the process may produce useful products other than hydrogen, which may be similarly collected and stored or used 130, and/or may be recycled into purified silicon 110. Optionally, the process may produce excess hydrogen that is not later used by a device; this hydrogen may be used as an energy source 105 to further purify and refine silicon 110.

The energy source 105 may be, for example, an electrical power generator (e.g. a wind or hydroelectric power generator), a chemical energy source (e.g. hydrocarbon fuel), an energy storage device (e.g. a battery), or another appropriate means of providing energy. Multiple energy sources may be used in place of a single one; according to an exemplary embodiment of this process, hydroelectric power, electrical power generated from wind turbines, and unused hydrogen fuel produced by later stages of the process may all be used in conjunction.

This energy source 105 may power the purification and refinement of silicon 110. Purification and refinement of the silicon may be accomplished through a variety of potential processes depending on its desired purity. For example, should high purity silicon be desired, a Siemens gas deposition process or a fluidized bed reactor process could be employed. In the preferred embodiment, high purity silicon will be produced by means of silane gas deposition on a seed rod according to the Siemens process.

Silicon produced via this process may be transported to a place of use 115, and may be used immediately or may be stored for later use. The place of use 115 is assumed to be distinct from where the silicon is purified and refined 110, but may be located nearby or even on the same apparatus or in the same chamber that was used for the deposition process. In an exemplary embodiment, the silicon may be stored as a cohesive solid, for example in the form of large bricks or boules; this may facilitate storage, reduce the amount of silicon dioxide that is formed by silicon reacting with oxygen in the atmosphere, and facilitate the use of silicon in a particular reaction apparatus. In another exemplary embodiment, the silicon may be stored as a powder.

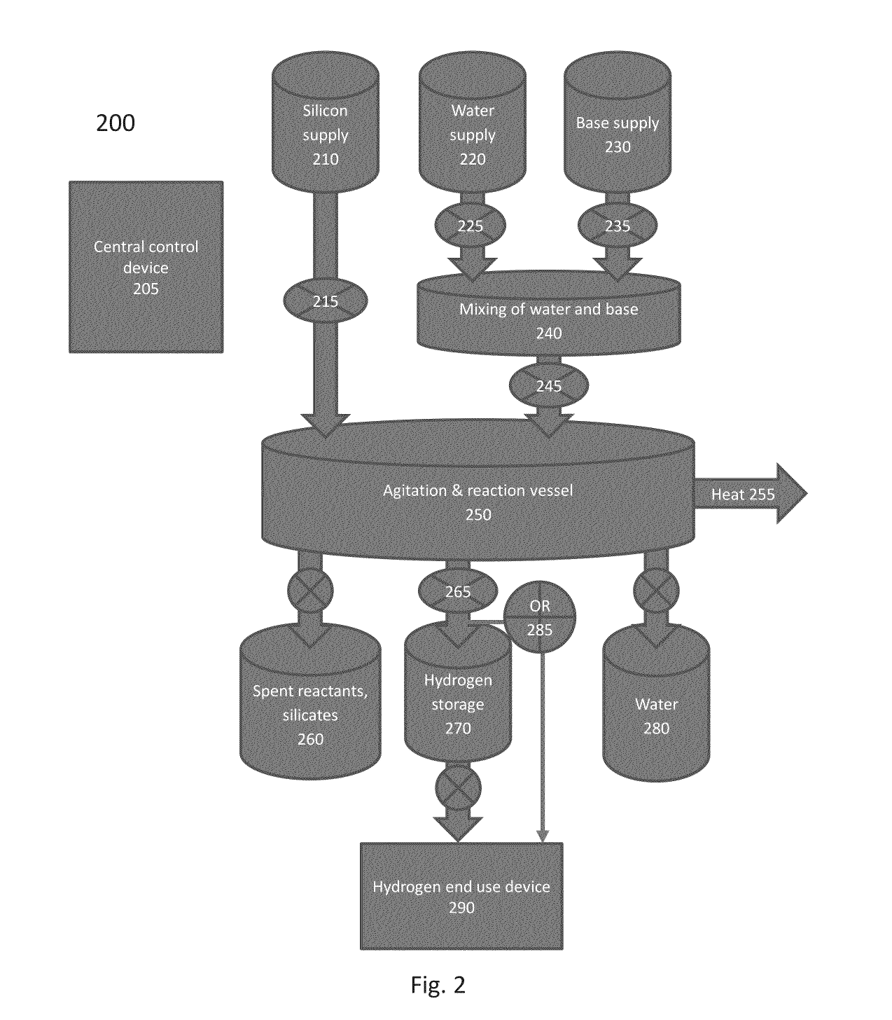

When desired, silicon may be reacted to produce hydrogen 120. This process is generally described in the apparatus displayed in FIG. 2; the process may require as inputs silicon, water, and/or a chemical base, and may yield hydrogen, silicates and/or other products. Optionally, the process may also allow for the retrieval of unused reactants should the process be terminated prematurely. The hydrogen produced via this process may be stored or may be directly used in a device 125, as desired.

Optionally, the waste materials from the reaction (silicates) may be captured, stored, and used or recycled as desired. Silicates are used in a number of other industrial processes, and may be recycled back into purified silicon, and could be put to either use. In the preferred embodiment, silicates will be recycled back into purified silicon 110 in order to reduce material and disposal costs Likewise, any excess hydrogen produced by the process may be employed directly as an energy source for further purification and refinement of silicon, or may be stored or released to the atmosphere, as desired.

FIG. 2 discloses an exemplary system 200 that may be used for reacting silicon to produce hydrogen in the manner described in the reaction stage 120. The system 200 is governed by a central control device 205, and employs a silicon supply 210, a water supply 220, and a supply of a chemical base 230. Water and the base may be mixed to produce a basic solution 240, which may then be reacted with silicon 250 to yield silicates and other products 260, hydrogen 265, and, potentially, unused reactants 280. Hydrogen 265 may be stored 270 in a dedicated hydrogen storage tank or elsewhere, or may be put to immediate use 285, 290.

The central control device 205 will control operation of the system and will add reactants as necessary to produce the desired amounts of hydrogen 265. The reaction rate may be controlled by the quantities of each reactant introduced into the agitation and reaction vessel 250. Silicon may be dispersed into the agitation and reaction vessel 250 from the silicon supply 210 via a valve or mechanically assisted system 215 controlled by the central control device 205. Alternatively, silicon may be placed directly into the agitation and reaction vessel 250. The alternative used may depend on factors like the size of the reaction chamber and the amount of available feedstock. An apparatus may employ one option or the other, or may be adapted to allow silicon to be added from both a valve or mechanically assisted system 215 and directly by a user. Silicon material of substantially any size and/or shape may be used, depending on factors like the size of the agitation and reaction vessel 250, the amount of hydrogen to be produced 265 or stored 270, the amount of other reactants 220, 230 available, the method by which the silicon is to be introduced into the agitation and reaction vessel 250, or based on any other such criteria.

According to one exemplary embodiment, silicon nanoparticles approximately 1 nm in diameter may be used, and may be introduced via a mechanically-assisted method 215 from a silicon supply 210. According to a second exemplary embodiment, bulk silicon may be added directly into the agitation and reaction vessel 250. The use of bulk silicon, such as larger boules or bricks, may be more advantageous in a setting in which this process is to be used for large-scale production of hydrogen gas for industrial purposes, while the use of silicon nanoparticles or silicon powder may be more advantageous when the system is to be used to produce limited and/or carefully controlled quantities of hydrogen. Different ranges of purity of the silicon may also be employed. One potential embodiment of the system may make use of silicon of greater than 99% purity, while another may make use of silicon of only 50% purity.

Water 220 may be employed as the primary source of the hydrogen 265. In alternative exemplary embodiments, other substances may be employed as a source of hydrogen, as would be understood by a person of ordinary skill in the art. The purity of the water may, similarly to the silicon, vary widely; it may include, e.g., seawater, rainwater, or water recycled from the flow out of an end use device which produces water as an end product. In an exemplary embodiment, water may be of greater than 99% purity in order to minimize the potential effects of other contaminants on the reaction and on the system as a whole 200. Water may be added 225 directly to the agitation and reaction vessel 250 or to an intermediate vessel 240 via the action of pressure, a pump, gravity, or another means desired. The source of this water 220 may be a municipal source, well, storage container, or another source, as desired. Addition of water 225 will be controlled by the central control device 205 and may be a primary means of controlling the rate of reaction. Water may be sprayed on the silicon feedstock in the agitation and reaction vessel 250 directly, mixed in an separate mixing chamber 240 with a dry ingredient 230 mechanically metered 235 to create a basic solution 245, or both water and a concentrated basic solution can be metered independently 235 by the central controller 205 into the agitation chamber 250.

The agitation and reaction vessel 250 may employ both chemical and mechanical means to facilitate the reaction and increase the rate of production of hydrogen. For example, the agitation and reaction vessel 250 may facilitate continued reaction of water with silicon by mechanically stripping or abrading the protective oxide layer from the silicon in the agitation chamber 250. Removal of this oxide layer on the silicon source materials may be accomplished via mechanical vibration, agitation, ultrasonic waves, tumbling, brushing, crushing, moving, or another desirable method. Different methods of varying intensity and frequency may be selected depending upon the size of the material being reacted and the rate of the reaction demanded.

Alternatively, or as a supplement to mechanically stripping the oxide layer, the agitation and reaction vessel 250 may chemically strip the oxide or reacted layer from the silicon in the agitation chamber 250. A chemical base 235 may be metered and added to the water 225 to create a basic solution 245, for example in a separate mixing chamber 240 prior to its introduction into the agitation and reaction vessel 245. This chemical base may be any chemical, element or compound used to create a basic solution in water 220; in the preferred embodiment, a chemical that promotes a more vigorous reaction may be used. The introduction of basic solution into the agitation and reaction vessel 250 may provide increased hydrogen production and continuous removal of the oxide layer, exposing more silicon for continued reaction. This may also cause the reaction to emit more heat 255. An example reaction that may occur when sodium oxide is added to the agitation chamber 250 is: 1 kg Si+1.4 kg Na₂O+3 kg H₂O→heat, silicates+0.34 kg H₂ (142 cu ft@14.7 psi 70 F, theoretical).

Mechanical agitation of the agitation and reaction vessel 250 and/or chemical stripping of the silicon feedstock 215 by a basic solution 245 may act to continuously remove the oxide layer formed on the surface of the silicon feedstock 215. This may promote the reaction Si+2H₂O→SiO₂+2H₂, enabling the production of hydrogen gas from the silicon feedstock 215 and water. The hydrogen produced in this manner 265 may be removed from the agitation and reaction vessel 250 via a gas outflow port, and may be stored, compressed and stored 270, used directly 285 in an end use device 290, used for an industrial purpose, or otherwise used as desired. Byproducts of the reaction, such as spent reactants, silicates 260, and excess water 280, can likewise be stored or used as desired. As previously identified in FIG. 1, silicates produced by this reaction may potentially be recycled 110 by re-purification of this material into silicon feedstock 215, which may reduce both material and disposal costs.

The reaction Si+2H₂O→SiO₂+2H₂ may produce a useful quantity of waste heat 255, which may also be recycled as is necessary or useful. For example, this waste heat may be collected and used to power the mechanical stripping or abrading of the silicon feedstock 215 in the agitation and reaction vessel 250, may be used to generate electricity in some other process, may be used for another industrial purpose, or may be used as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1-8. (canceled)

9. A system for generating hydrogen gas from silicon, comprising:
a silicon supply;
a water supply;
an agitation and reaction vessel permitting both silicon and water to be supplied to it; and
a gas outflow port permitting the release of hydrogen gas from the agitation and reaction vessel.

10. The system of claim 9, wherein the system further comprises a supply of a chemical base to be added to the agitation and reaction vessel.

11. The system of claim 10, wherein the chemical base is mixed with the water in a separate mixing chamber before being supplied to the agitation and reaction chamber.

12. The system of claim 9, wherein the agitation and reaction vessel is configured to mechanically strip the oxide layer from the silicon supplied to it.

13. The system of claim 9, wherein the agitation and reaction vessel generates a quantity of waste heat and wherein this waste heat is utilized to do mechanical work.

14. The system of claim 9, wherein silicate products of the reaction are captured and removed from the agitation and reaction vessel following the completion of a reaction.

15. The system of claim 9, wherein silicate products of the reaction are captured and removed from the agitation and reaction vessel while a reaction is ongoing.

16. The system of claim 9, wherein the hydrogen generated within the agitation and reaction vessel is immediately supplied to a hydrogen-powered end use device.

17. The system of claim 9, wherein the hydrogen generated within the agitation and reaction vessel is stored for later use.

18. The system of claim 9, wherein the rate of reaction is controlled by a central control device.

19. The system of claim 9, wherein excess hydrogen produced in the agitation and reaction vessel is used as a power source for the purification and refinement of silicon.

20. A system for generating hydrogen gas from silicon, comprising:
a silicon supply;
a water supply;
a supply of chemical base;
a separate mixing chamber supplied by both the water supply and the supply of chemical base;
an agitation and reaction vessel supplied by the silicon supply and by the separate mixing chamber, and which is configured to mechanically strip the oxide layer from silicon; and
a gas outflow port permitting the release of hydrogen gas from the agitation and reaction vessel.
